(19) United States
(12) Patent Application Publication
(10) Pub. No.: US 2012/0313582 A1
(43) Pub. Date: Dec. 13, 2012

(54) HAND TOOL HAVING AT LEAST ONE INTEGRATED BATTERY CELL

(76) Inventor: Jan BREITENBACH, Stuttgart (DE)

(21) Appl. No.: 13/444,435

(22) Filed: Apr. 11, 2012

(30) Foreign Application Priority Data
Apr. 27, 2011 (DE) 102011017576.8

(51) Int. Cl. B25F 5/02; H02J 7/00

(52) U.S. Cl. 320/112; 81/489

(57) ABSTRACT

In a hand tool having at least one integrated battery cell, a pen-shaped tool housing is provided, and the battery cell is connectable to a charger for charging, which is designed to charge removable battery packs.

### CROSS REFERENCE

The present application claims the benefit under 35 U.S.C. §119 of German Patent Application No. DE 102011017576.8 filed on Apr. 27, 2011, which is expressly incorporated herein by reference in its entirety.

### FIELD OF THE INVENTION

The present invention relates to a hand tool having at least one integrated battery cell.

### BACKGROUND INFORMATION

In conventional hand tools having at least one integrated battery cell, the battery cell is designed to supply a power consumer assigned to the hand tool with power. The power consumer implements, for example, a drive unit for driving an insert tool, e.g., a screwdriver bit.

The battery cell of a hand tool of this type is often chargeable via a wired charger, the battery cell being connected via a first plug and a cable, electrically conductively connected to this plug, to a charger unit which is provided with a second plug connectable to an AC voltage network, for example. Chargers of this type are also used for charging battery cells in mobile phones.

One disadvantage is that chargers of this type are usable for charging a battery cell of a hand tool only in a limited manner since they are executable only for relatively low charging currents, making a rapid charging of the battery cell impossible. Furthermore, the electrically conductive connection between the first plug and the battery cell is prone to vibrations and other external influences such as strikes or blows. In addition, the cable connection between the first and the second plugs is prone to cable breaks. For these reasons, a professional application of this type of hand tools is made at least more complicated.

### SUMMARY

An object of the present invention is to provide a novel hand tool having an integrated battery cell which is chargeable safely and reliably and in a simple manner.

This object is achieved with the aid of a hand tool having at least one integrated battery cell, a pen-shaped tool housing being provided and the battery cell being connectable for charging to a charger which is designed to charge removable battery packs.

The present invention thus allows the provision of a hand tool provided with an integrated battery cell which has miniaturized dimensions and whose battery cell is chargeable in a simple and rapid manner.

According to one specific embodiment, the battery cell has a cell housing which is designed to enable a configuration of the battery cell in an insertion slot associated with the charger.

A robust and safe battery cell may thus be provided.

The cell housing and the tool housing are preferably designed as a single piece.

A hand tool having a cost-effective and compact design may thus be provided.

According to one specific embodiment, the battery cell has an interface which has a first data connection for transferring charge encoding data and/or a second data connection for transferring temperature data to the charger.

The present invention thus allows the provision of a battery cell interface which may ensure safe and rapid charging of the battery cell.

The interface of the battery cell is preferably designed in the form of an interface of a removable battery pack provided for charging using the charger.

It is thus possible to draw on a customary removable battery pack interface to provide the battery cell interface in an uncomplicated and cost-effective manner.

The interface of the battery cell is preferably designed to allow the battery cell to be electrically conductively connected to an interface which is associated with the charger.

A simple and wireless connection between the battery cell and the charger for charging the battery cell may thus be provided.

According to one specific embodiment, the tool housing has a covering cap, which may be slid at least in sections onto the battery cell and which is provided for covering the battery cell during operation of the hand tool.

The present invention thus allows a safe and reliable protection of the battery cell and its interface during operation of the hand tool.

According to one specific embodiment, an electromotive drive unit which is permanently connected to the battery cell is provided for driving an insert tool.

A miniaturized electric tool may thus be provided in a simple manner.

The battery cell preferably has a 3.6 V Li-ion cell.

A cost-effective and customary battery cell may thus be used when the hand tool is implemented.

According to one specific embodiment, the hand tool has an outside diameter of less than 30 mm.

The present invention thus allows a solid hand tool having a compact design and reduced dimensions to be provided.

The object mentioned at the outset is achieved with the aid of a system having a charger, a removable battery pack and a hand tool having at least one integrated battery cell. The battery cell and/or the removable battery pack are connectable to the charger for charging. The hand tool is designed in the form of a pen.

The object mentioned at the outset is furthermore achieved with the aid of a pen-style tool having an electromotive drive unit.

The object mentioned at the outset is furthermore achieved with the aid of a charger which is electrically conductively connectable to a removable battery pack and/or at least one battery cell integrated into a pen-shaped hand tool for carrying out a charging operation.

### BRIEF DESCRIPTION OF THE DRAWINGS

The present invention is explained in detail below with reference to the exemplary embodiments illustrated in the figures.

FIG. 1 shows a side view of an example hand tool according to the present invention.

FIG. 2 shows a side view of the example hand tool of FIG. 1 having the covering cap removed.

FIG. 3 shows a perspective view of the example hand tool of FIGS. 1 and 2 which is situated in an insertion slot of an associated charger.

FIG. 4 shows a perspective view of the interface provided on the battery cell of the example hand tool of FIGS. 1 through 3.

FIG. 5 shows a perspective view of a removable battery pack usable with the charger of FIG. 3.

### DETAILED DESCRIPTION OF EXAMPLE EMBODIMENTS

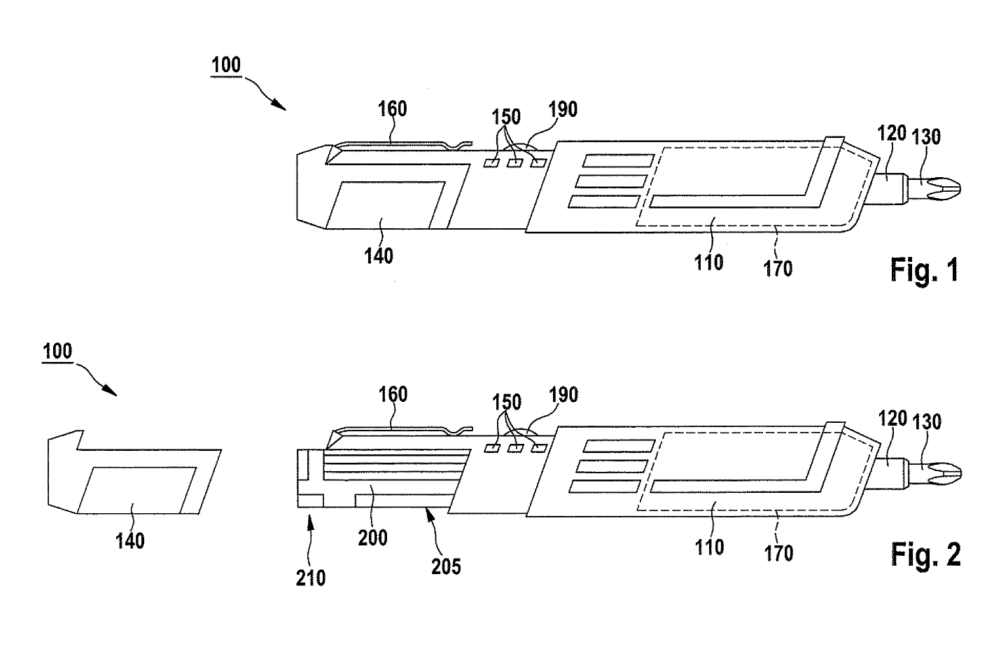

FIG. 1 shows a hand tool 100 having a pen-shaped tool housing 110 according to the present invention. This pen-shaped hand tool 100 preferably has an outside diameter of less than 30 mm and particularly preferably an outside diameter of approximately 22 mm, and is thus also referred to as “pen-style tool” in the following description.

According to the illustration, pen-shaped tool housing 110 has a covering cap 140 and a spring-like clip 160 which are situated on an axial end area of pen-style tool 100. Clip 160 may be provided either on covering cap 140 or on tool housing 110. On the opposite axial end area of pen-style tool 100, a tool holder 120 is provided, for example, for holding insert tools, e.g., a screwdriver bit 130. Moreover, pen-style tool 100 may have one or multiple optional indicator lights 150 which are provided to display the state of charge and/or other operating parameters, for example.

According to one specific embodiment, an electromotive drive unit 170 (illustrated using dashed lines) for driving screwdriver bit 130 is situated in tool housing 110, the drive unit being operatable via a manual switch 190, for example. It is, however, pointed out that the illustration of screwdriver bit 130 is an example only and does not pose any limitations to the present invention. In fact, a plurality of other insert tools may be used, e.g., mini drilling tools, mini milling cutters, mini sanding tools, etc.

Electromotive drive unit 170 may, for example, have a drive motor which may be switched on and off via manual switch 190 and may be any type of motor, e.g., an electronically commuted motor or a DC motor. Preferably, this drive motor may be controlled or regulated electronically in such a way that reverse operation and specifications with regard to a desired speed or variable rotational speeds are implementable. The principle of operation and the design of a suitable electromotive drive unit are sufficiently known to those skilled in the art so that a detailed description thereof is dispensed with for the sake of a concise description.

FIG. 2 shows pen-style tool 100 having its covering cap 140 removed to illustrate a battery cell 200 integrated into pen-style tool 100, the battery cell having a single 3.6 V Li-ion cell, for example. This Li-ion cell is permanently connected to electromotive drive unit 170 to provide drive unit 170 with the operating voltage necessary for driving screwdriver bit 130 during operation of pen-style tool 100. Covering cap 140 may be slid at least in sections onto battery cell 200 to cover it during operation of pen-style tool 100 and to protect it against contaminants.

As shown in FIG. 2, battery cell 200 has a cell housing 205 which is fastened to tool housing 110, for example, by gluing or welding. Alternatively, tool housing 110 and cell housing 205 are designed as a single piece. For this reason, pen-style tool 100 may be provided with an outer diameter which corresponds approximately to the outer diameter of battery cell 200 used plus a wall thickness associated with cell housing 205 or tool housing 110.

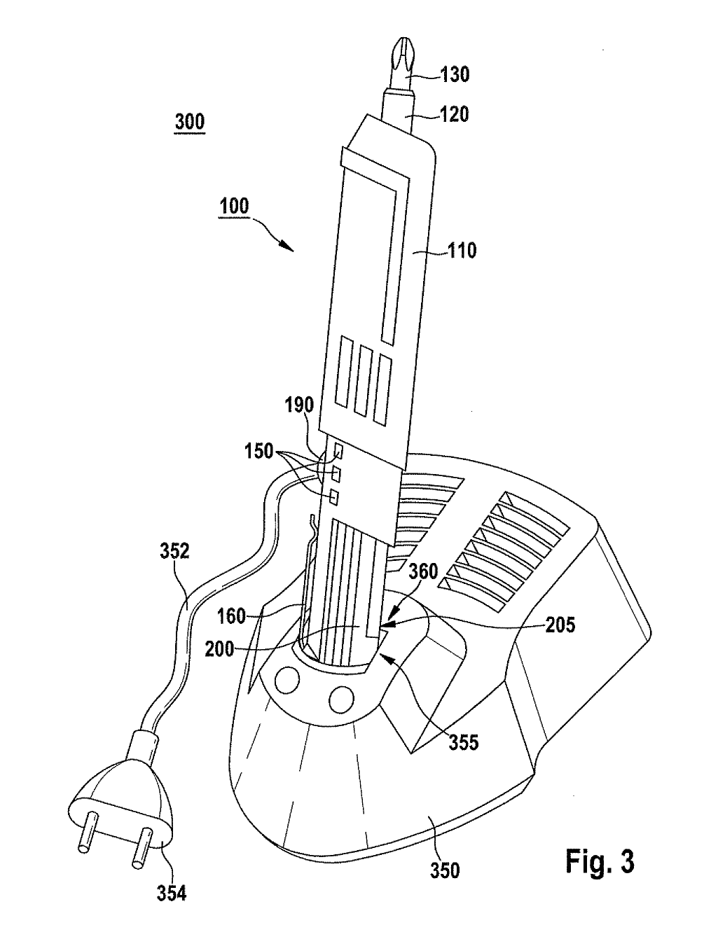

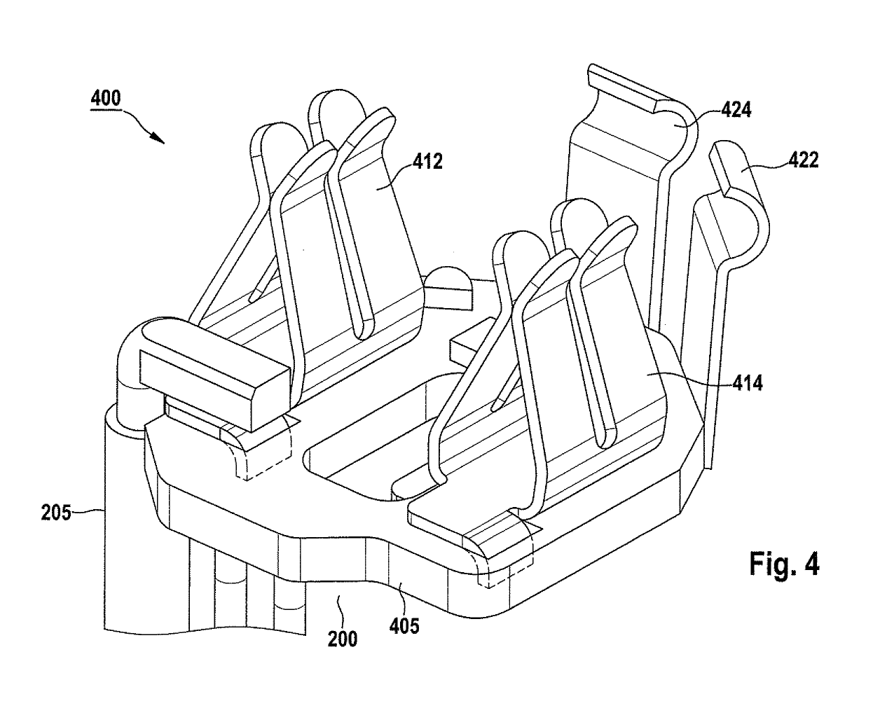

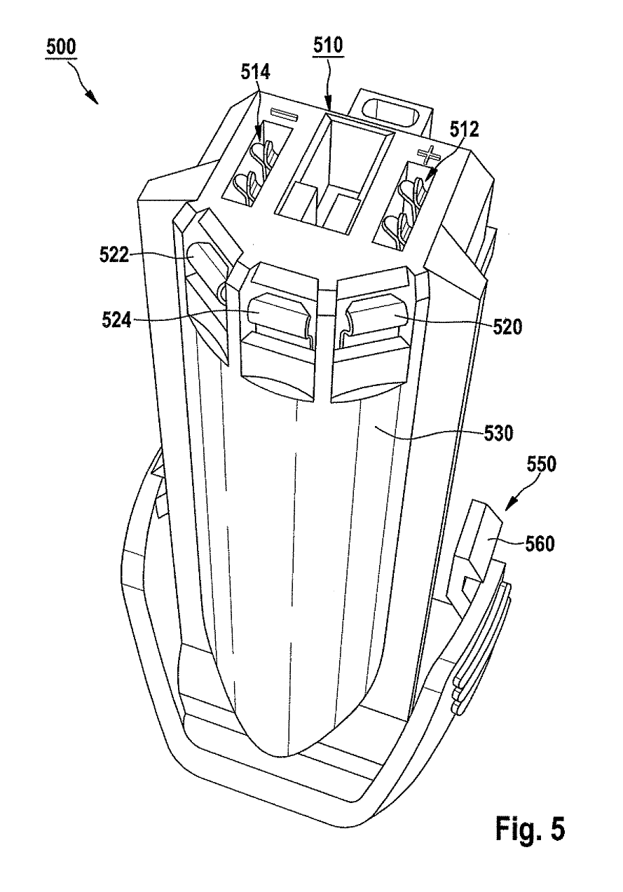

According to one specific embodiment, battery cell 200 is connectable to a charger (350 in FIG. 3) for charging. For this purpose, battery cell 200 has an interface 210 which is designed to enable an electrically conductive connection of battery cell 200 to an interface (360 in FIG. 3) of charger (350 in FIG. 3) for charging battery cell 200. Interface 210 of battery cell 200 is designed in the form of an interface (510 in FIG. 5) of a removable battery pack (e.g., removable battery pack 500 in FIG. 5) provided for charging using the charger (350 in FIG. 3), as described below for FIG. 4.

FIG. 3 shows a configuration 300 having pen-style tool 100 of FIGS. 1 and 2 and an exemplary charger 350 which is shown to have a cable 352 having a plug 354 for connecting to an AC voltage network during operation of charger 350. It is, however, pointed out that the description of the use of an AC voltage network for operating charger 350 is an example only and does not pose any limitations to the present invention. The present invention may also be applied to chargers provided for operation in direct voltage systems.

According to one specific embodiment, charger 350 is designed to charge removable battery packs (e.g., removable battery pack 500 in FIG. 5), 3.6 V and/or 10.8 V Li-ion removable battery packs by Robert Bosch GmbH, for example, and has at least one insertion slot 355 in which an interface 360 is provided for contacting battery cell interface 210 of FIG. 2. The at least one insertion slot 355 is used to hold cell housing 205 of battery cell 200 at least sectionally.

Charger 350 is shown to be designed in the form of a charging station or a so-called docking station for wireless energy transfer. A suitable charger may be used, and a detailed description of the design and principle of operation of charger 350 is dispensed with for the sake of a concise description.

FIG. 4 shows an exemplary interface 400 which may be used when implementing interface 210 of battery cell 200 of FIGS. 2 and 3. Interface 400 is shown to have a mount section 405, which may be fastened to battery cell 200 or cell housing 205, by, for example, gluing, welding, clamping, latching, etc. Two power connections 412, 414, which are designed in the form of tulip contacts, and two data connections 422, 424, which are designed in the form of spring contacts, are situated on mount section 405 by way of an example.

Power connections 412, 414 are used to transfer current, i.e., power, from charger 350 of FIG. 3 to battery cell 200. Data connection 422 is used to transfer temperature data from battery cell 200 to charger 350 of FIG. 3, and data connection 424 is used to transfer charge encoding data or charge parameters from battery cell 200 to charger 350 of FIG. 3. Charge encoding data indicate a voltage at the end of charging or a maximally admissible temperature while charging, for example. Moreover, data connections 422, 424 may also be designed to transfer other data, e.g., operating data which are recorded by it during operation of pen-style tool 100 of FIGS. 1 through 3. Alternatively, an additional data connection may be provided for this purpose, for example.

FIG. 5 shows a removable battery pack 500 as an example which forms a charging system together with pen-style tool 100 of FIGS. 1 through 3 and charger 350 of FIG. 3. Removable battery pack 500 has a single 3.6 V Li-ion cell as an example and is connectable to charger 350 of FIG. 3 for charging, as well as pen-style tool 100 of FIGS. 1 through 3. In the event that charger 350 of FIG. 3 has multiple insertion slots 355 as described above, pen-style tool 100 of FIGS. 1 through 3 and removable battery pack 500 may be charged simultaneously using charger 350 of FIG. 3.

According to one specific embodiment, removable battery pack 500 has a battery housing 530 on which snap-in locking devices 550 having snap-in tongues 560 for locking removable battery pack 500 to an associated power tool, for example, are provided. Removable battery pack 500 is shown to have an interface 510 having two power connections 512, 514, which are designed in the form of tulip contacts by way of example, as well as three data connections 520, 522, 524, which are designed in the form of spring contacts by way of example.

Power connections 512, 514 are used to transfer current, i.e., power, from charger 350 of FIG. 3 to removable battery pack 500. Data connection 522 is used to transfer temperature data from removable battery pack 500 to charger 350 of FIG. 3, and data connection 524 is used to transfer charge encoding data or charge parameters from removable battery pack 500 to charger 350 of FIG. 3. Data connection 520 is used to transfer a battery pack code to an associated power tool. Since this type of transfer of a battery pack code may be dispensed with for pen-style tool 100 of FIGS. 1 through 3, since battery cell 200 of FIGS. 2 through 4 is fixedly integrated into pen-style tool 100 of FIGS. 1 through 3, an illustration of a corresponding third data connection was dispensed with in FIG. 4 for the sake of simplicity and clarity as described above.

What is claimed is:

1. A hand tool, comprising:
a pen-shaped tool housing; and
at least one integrated battery cell, the battery cell being connectable to a charger for charging, the charger being designed to charge removable battery packs.

2. The hand tool as recited in claim 1, wherein the battery cell has a cell housing which is designed to enable a configuration of the battery cell in an insertion slot associated with the charger.

3. The hand tool as recited in claim 2, wherein the cell housing and the tool housing are a single piece unit.

4. The hand tool as recited in claim 1, wherein the battery cell has an interface which has at least one of a first data connection for transferring charge encoding data, and a second data connection for transferring temperature data to the charger.

5. The hand tool as recited in claim 4, wherein the interface of the battery cell is in a form of an interface of a removable battery pack provided for charging using the charger.

6. The hand tool as recited in claim 4, wherein the interface of the battery cell is designed to enable an electrically conductive connection of the battery cell to an interface associated with a charger.

7. The hand tool as recited in claim 1, wherein the tool housing has a covering cap which may be slid at least in sections onto the battery cell and which covers the battery cell during operation of the hand tool.

8. The hand tool as recited in claim 1, further comprising:
an electromotive drive unit to drive an insert tool, the electromotive drive unit being permanently connected to the battery cell.

9. The hand tool as recited in claim 1, wherein the battery cell has a 3.6 V Li-ion cell.

10. The hand tool as recited in claim 1, wherein the hand tool has an outer diameter of less than 30 mm.

11. A system, comprising:
a charger;
a removable battery pack; and
a hand tool provided with at least one integrated battery cell;
wherein the battery cell and the removable battery pack are connectable to the charger for charging and the hand tool, the hand tool being in a form of a pen.

12. A pen-style tool having an electromotive drive unit.

13. A charger which is electrically conductively connectable to a removable battery pack and at least one battery cell integrated into a pen-shaped hand tool for carrying out a charging operation.
